(19) United States
(12) Patent Application Publication
(10) Pub. No.: US 2014/0192626 A1
(43) Pub. Date: Jul. 10, 2014

(54) Talking Dome Watch for the Visually Impaired

(71) Applicants: Kathleen Wolff, Arlington, VA (US); Scott William Doyle, Potomac, MD (US)

(72) Inventors: Kathleen Wolff, Arlington, VA (US); Scott William Doyle, Potomac, MD (US)

(73) Assignee: Royal Hali Iplik Tekstil Mobilya Sanayi Ve Ticaret Anonim Sirketi, Gaziantep (TR)

(21) Appl. No.: 14/001,012

(22) PCT Filed: Mar. 2, 2012
(86) PCT No.: PCT/US12/27506

§ 371 Date: Mar. 3, 2014

Related U.S. Application Data
(60) Provisional application No. 61/448,510, filed on Mar. 2, 2011.

(51) Int. Cl. G04C 21/14

(52) U.S. Cl. CPC G04C 21/14
USPC 368/63; 368/185

(57) ABSTRACT

A watch includes a first input for a actuating an audible announcement of the time and a second input for adjusting a volume of the announcement. The first input produces a second signal that changes an operating mode of the watch to a second operating mode in which a second parameter is adjusted by the second input. The first input is a cover or glass of the watch and the second input is a rotatable bezel.

### CROSS-REFERENCE TO RELATED APPLICATION

This application claims the benefit of U.S. Provisional Patent Application No. 61/448,510, filed on Mar. 2, 2011, which is hereby incorporated by reference in its entirety.

### BACKGROUND OF THE INVENTION

1. Field of the Invention

The present invention relates generally to a reliable watch for providing time and related functions through an improved easy to use talking interface.

2. Description of the Prior Art

The wrist watch is a universally practical appliance that is worn by most everyone to tell time. In addition, many wear watches as a fashion accessory, and even, in some instances, as a status symbol. The quality of many watches has reached great heights by combining the highest states of precision with the elegance of jewelry in many instances.

Unfortunately, these refinements in the functionality and appearance of watches leading to high reliability have not translated into such high quality watch designs for the vision impaired. In fact, just the opposite has occurred. Several watches have been conventionally sold that provide audible indications of the time to be heard by the user. These are known in the art as “talking watches.” Current watch designs for the vision impaired lack style, aesthetics or high quality. The watches are unattractive with outsize digital characters to show the time on the watch face, for example. Conventional vision impaired watches, however, are typically made of cheap material (e.g., plastic), difficult to use (impossible for vision impaired in many cases to set the time), and last for only a short period of time. Such watches are made of plastic or cheap metals. Currently, studies show that more than 500,000 talking watches are sold annually in the United States. These products, however, often malfunction within days. In a recent survey performed by the inventors, 81% of the surveyed vision impaired people indicated they owned a talking watch. Of these owners, an astounding 41% said that their talking watch stopped working. In general, these owners complained of the very low quality of such watches. The sad fact is that these watches are made on the cheap. If any water gets on these conventional watches, there is a decent chance the watches will cease to operate. In fact, the inventors could not find any waterproof talking watches in the marketplace.

In addition, little to no advanced features have been added to these watches over the last thirty years. No devices currently exist in the art, particularly no device of wrist watch size exists in the art that combines stylish high quality features of good watches with the functionality necessary to dramatically improve the everyday life of the vision impaired. For example, no watches are waterproof or allow the user to set and program the watch with spoken commands, eliminating the need of a care giver to perform such tasks. Moreover, there are no wrist watches currently designed for the blind or vision impaired that include state-of-the-art electronic functions that help the vision impaired avoid accidents by broadcasting warnings of potential dangers.

### SUMMARY OF THE INVENTION

These and other problems are generally solved or circumvented, and technical advantages are generally achieved, by embodiments of the present invention in which high quality functions and features are incorporated into the watches for the vision impaired. Easy activation of buttons allows a vision impaired person to easily enter time and date information either through easy manual depression of buttons or through novel speaker recognition approaches without the assistance of a care giver.

In one embodiment, the reliability of talking watches is substantially enhanced through a design that makes the watch water resistant through a novel sealing mechanism. This mechanism protects the interior of the watch from water while continuing to provide for the important speaker functionality necessary to provide easy to understand audio messages to the user. In addition, the watch provides the ability for the user to select variable audio sound levels.

In one embodiment, the watch maintains precise time by receiving atomic time by way of wireless networks. In this manner, the time can be adjusted automatically, if necessary, every night by receipt of proper time via satellite, for example.

Another historical problem with watches designed for the viewing impaired is the lack of customer support when the watch malfunctions. This problem is magnified given the inability of many vision impaired to try to reset the watch upon a malfunction. One embodiment of the invention solves this problem in a unique manner by constantly internally evaluating the operating conditions of the watch. If a problem is identified—for example, the watch stops telling time—a message is formatted and transmitted to a backend site by way of a wireless network. This condition is reported to a customer agent through a PC or other device, and the customer agent will call the user to help determine the cause of the problem.

In one embodiment, a voice recognition unit within the watch allows the user to set alarms, the time, or other information. This feature eliminates the hassle that the vision impaired would have to go through in the past trying to set alarms or the time on small non-user friendly watches with difficult dials or buttons, or by requiring a care giver to make such settings.

In one embodiment, the watch can receive important alert messages indicating emergencies via the Emergency Broadcasting System, extreme weather conditions, directions, or even dining suggestions based on the proximity of the watch user to local restaurants. In this system, a remote entity sends out messages over the private or public networks such as cellular networks. The alert messages are reported to the watch via a transmission over a wireless communications network. The watch preferably contain an onboard demodulator/detector that can detect and process the message. Via a subscription or other like plan, the user has entered in what types of alerts he or she would like to receive from the network. These interactive responses are stored and correlated into a user profile maintained at a server. When certain events occur, messages are tagged and forwarded over the communications network to all users who have these attributes tagged in their profiles, for example. Upon receipt and detection of an alert message, the watch may simply vibrate to indicate an emergency situation or other message, or the watch can play a prerecorded audio message indicating the content of the alert or other message.

In another embodiment, a system and method for evaluating the health of the wrist watch user is disclosed. As the baby boomers approach old age, remote monitoring of health conditions takes on more significance and allows more freedom for the patient. While remote monitoring systems have been designed, none have made use of a watch as a remote monitoring unit. This embodiment comprises selecting one or more parameters to be monitored, wherein the parameters are associated with vital health functions such as heart rate, and wherein the parameters are monitored by a monitoring sensor preferably placed on the back side of the watch, selecting one or more violation thresholds for each parameter, detecting occurrences of the violation threshold, and evaluating the driver's performance based upon the occurrences of the violation conditions. In more advanced versions, a patient could enter into the watch other health parameters for transmission over the network. Further, simple messages that do not take much bandwidth, and thus can be formatted into a small number of packets, can be sent from the watch to a server via a network. Such messages can include a request for emergency assistance, for example.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and 1B depict one wrist watch embodiment for the vision impaired;

FIG. 2 is a block diagram of the components of a preferred watch embodiment;

FIGS. 3A and 3B are views of the sealing mechanism used in the wrist watch for eliminating or substantially reducing damage due to water or liquids;

FIGS. 3C and 3D are views of another embodiment of the wrist watch;

FIGS. 3E and 3F are schematic diagrams showing steps of operation of the wrist watch of FIGS. 3C and 3D;

FIG. 3G is a view of a further embodiment of the watch showing a sliding adjustment input;

FIG. 3H is a view of a further embodiment of the watch showing a toggle input;

FIG. 4 is a high level block diagram illustrating a communication system for providing alarms and other information to the wrist watch device; and

FIG. 5 is a flowchart illustrating a method for communicating information to the wrist watch such as alarms and other information according to another embodiment described herein.

### DETAILED DESCRIPTION

The present invention provides many applicable inventive concepts that can be embodied in a wide variety of specific contexts. The specific embodiments discussed are merely illustrative of specific ways to make and use the invention, and do not limit the scope of the invention.

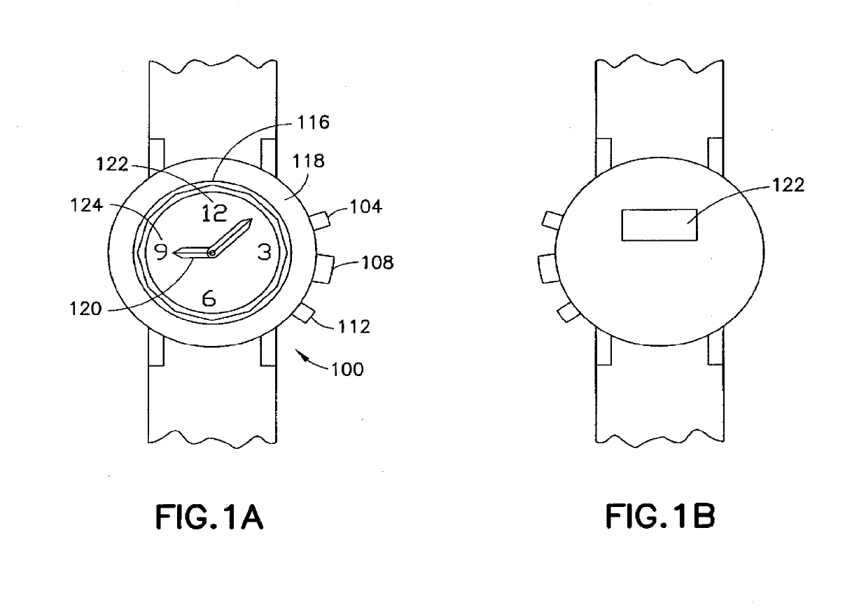

FIGS. 1A and 1B depict top and bottom views of the watch. As shown, the watch appears to look like normal high quality watches. Although the watches of the invention have many enhanced features and functions for the vision impaired, the watches are designed in an innovative manner with an appearance that looks just like good quality regular watches. These designs, however, are distinguished from current talking watches on the market that are of poor design, use cheap materials, and have poor aesthetics which make them look different from regular watches, and poor reliability that lead them to fail as much as half the time. The watch of the present invention is designed to overcome these shortcomings while at the same time provide a normal appearance of a high quality regular watch made by a reputable manufacturer. In this manner, the enhanced functionality of the watch and the components of the watch shown in FIGS. 1 through 3 are easily transferable to many different watch designs for ladies, men and children.

Preferably, the watch casing 118 is made of a strong material such as steel. Of course, the watch could also be made of other strong materials including aluminum, silver, gold, platinum, or any other watch materials known in the art.

In one embodiment, push button 104 allows the user to easily hit the button and the watch to automatically synchronize both hands to atomic time. Access to atomic time allows for the watch to constantly adjust the time electronically to the proper time. In one embodiment, the watch maintains precise time by receiving atomic time by way of wireless networks. In this manner, the time can be adjusted, if necessary, every night by receipt of proper time via satellite, for example. In addition, the atomic time input to the watch updates daylight saving time automatically.

In one embodiment, the watch dials 120 and number notations 122 are made of a material that is luminant. In this manner, the dials and numbers may be clearly visible at night.

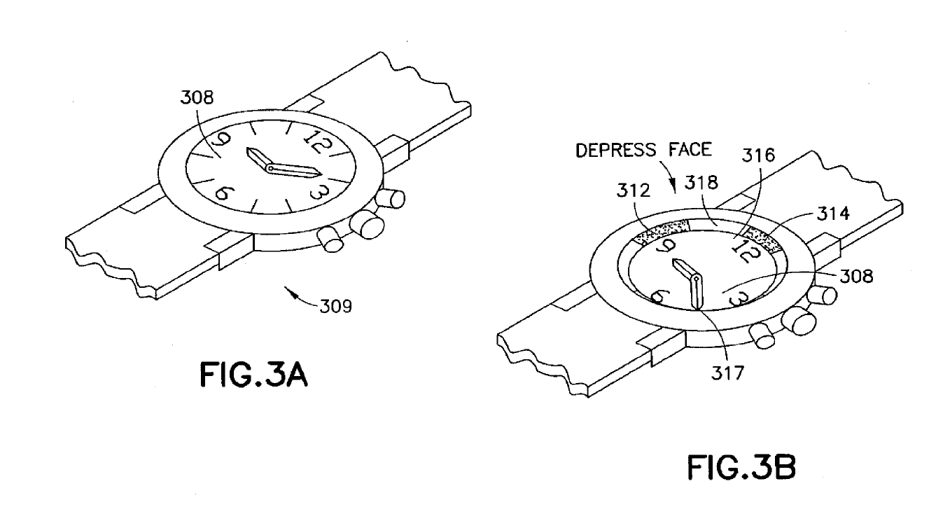

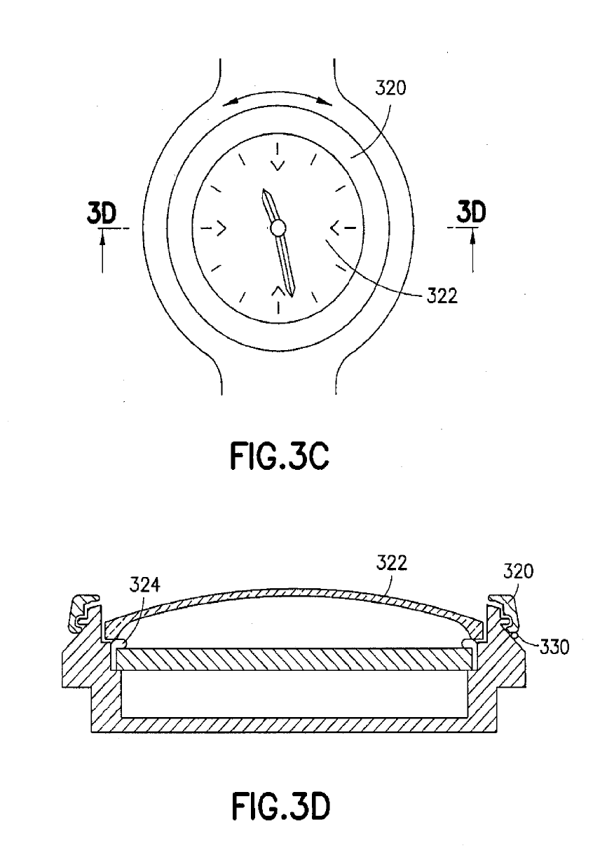

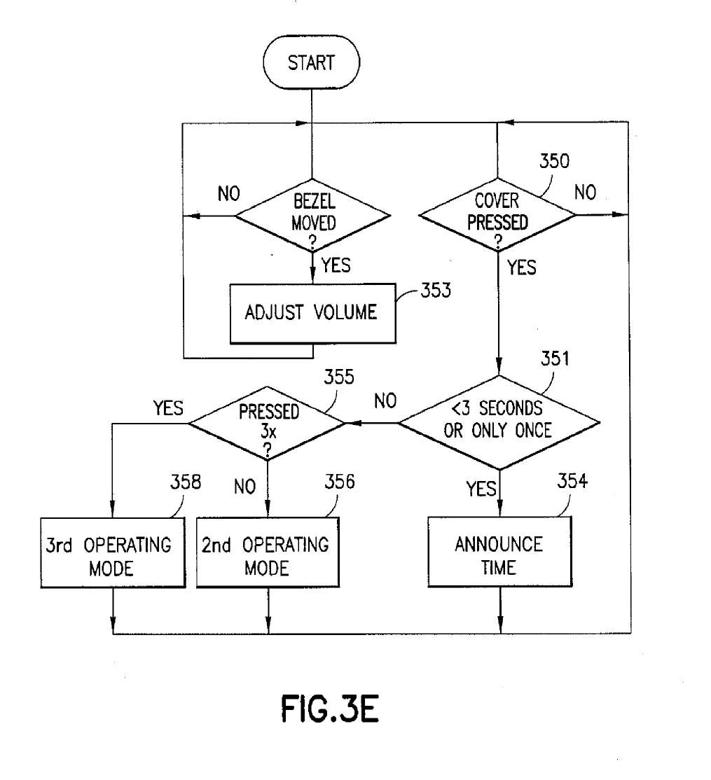

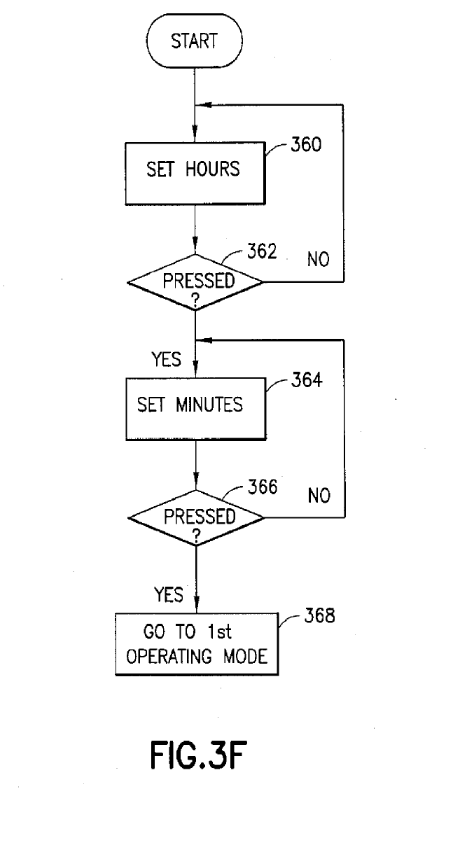

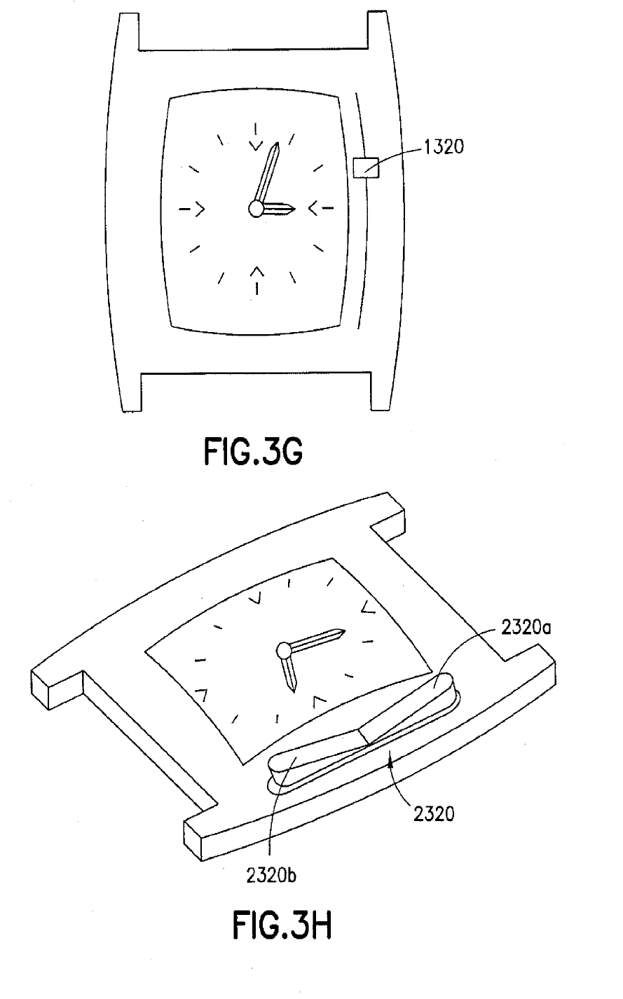

In one embodiment, the user may use the dial 104 to set the time manually. Alternatively, the user may depress button 112 and clearly speak the time. A speech detection system within the watch can convert the spoken words to commands that will automatically reset the watch. The mini-microphone is described with reference to FIG. 3.

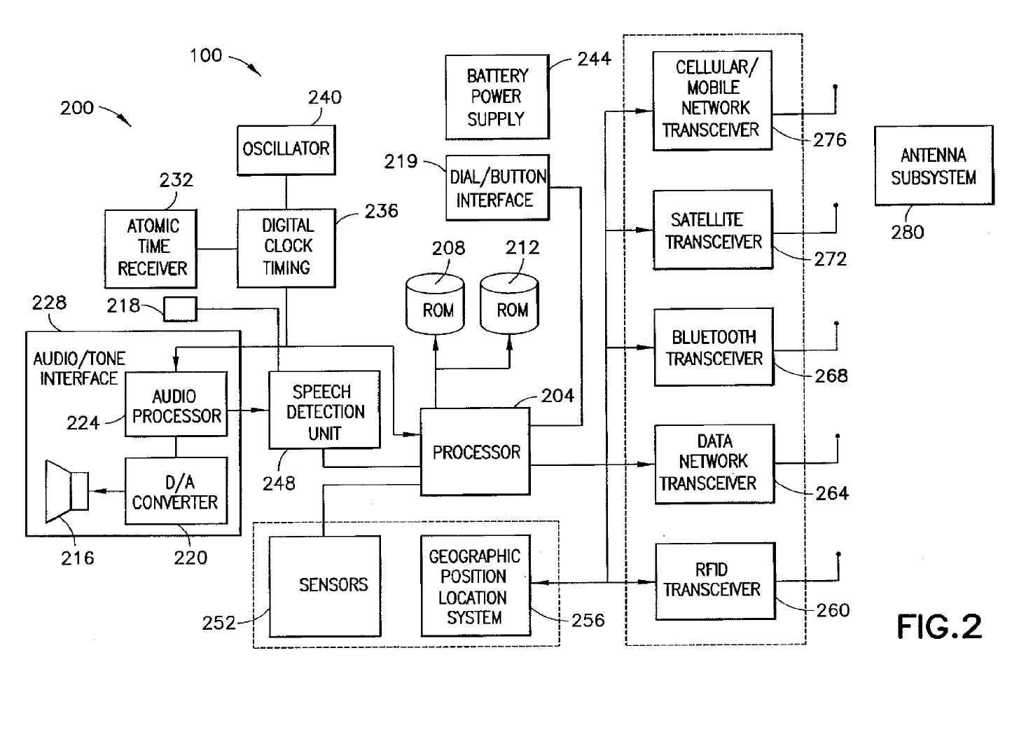

With reference to FIG. 2, there is shown the components of one embodiment of the talking watch. Not all components are necessary, but depend on which applications are actually used by the watch. A digital processor 204 controls the operation of the talking watch. Atomic time is received by way of the atomic time receiver 232. The receiver 232 interfaces with the digital clock timing system. The digital watch can also work in an embodiment without atomic time using the digital clock timing component 236 and the oscillator 240.

Processor 204 may be a general use processing device having software designed to control the watch. Alternatively, processor 204 may be a specially designed circuit or device, such as an application specific integrated circuit (ASIC), that is particularly designed for use in the unit. Processor 204 may use firmware or software, such as an operating system, for control and operation. Firmware, software and other data may be stored in random access memory (RAM) 208, read only memory (ROM) 212, electrically erasable programmable memory (EEPROM) devices, or other storage devices, such as magnetic media or flash memory.

The talking watch includes one or more interfaces 218, 219 and 228 that allow the user to interact with the watch. Signals exchanged between interface and the watch allow the user to determine the time on the watch, set alarms on the watch, or perform diagnostics on the watch. Audio and tone depictions of the current time, date, alarms or other events are provided by the audio tone interface 228 comprising the audio processor and a digital to analog converter 220. Such audio or tone responses are provided through methods known to one skilled in the art. Thus, if the user wants to know the time, he or she depresses button 104 shown in FIG. 1. The button interface component 219 sends an instruction to the processor 204. Upon receiving the instruction, the processor sends an instruction containing the current time (and date—optional) to the audio processor 224. The audio processor 224 has a small library of words for the time applications, alarms, and any other applications incorporated into the watch. The audio processor selects or generates the particular HOUR and MINUTES words and directs these digital words to the digital to analog converter 220. In another embodiment, the digit words are broadcast and the digital to analog converter 220 is not necessary. After converting the words to analog, the speaker plays back the words.

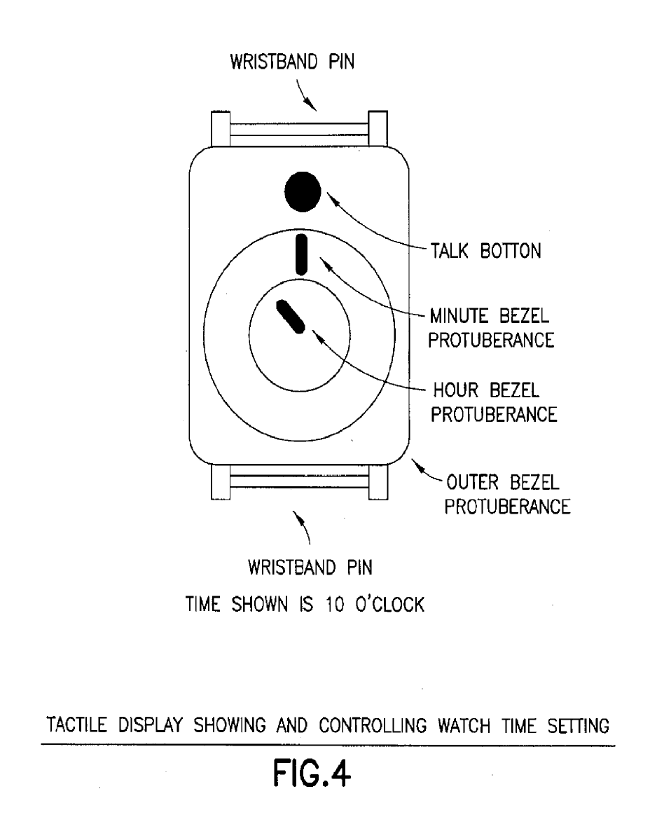

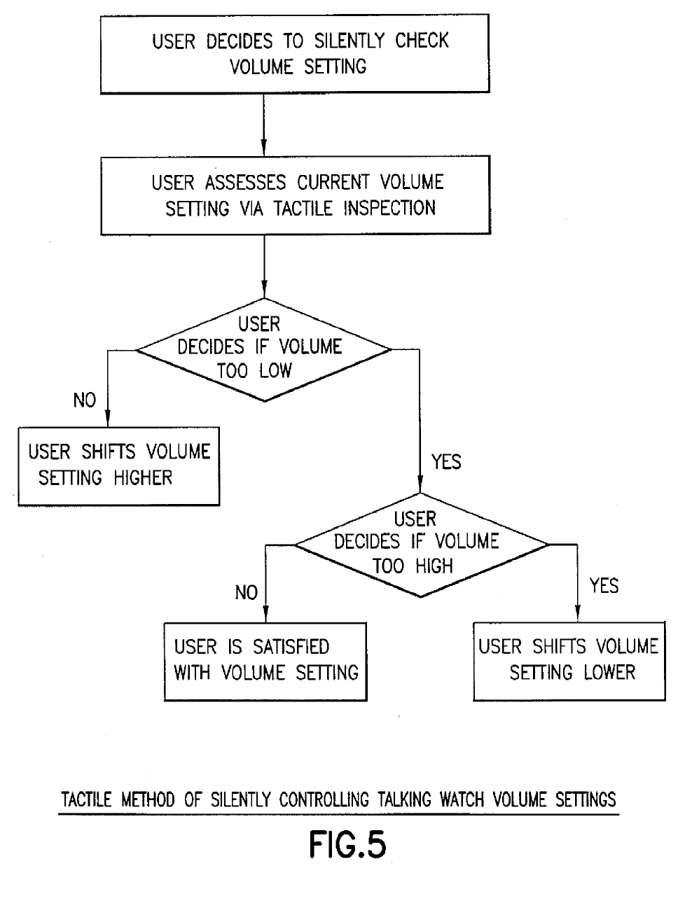

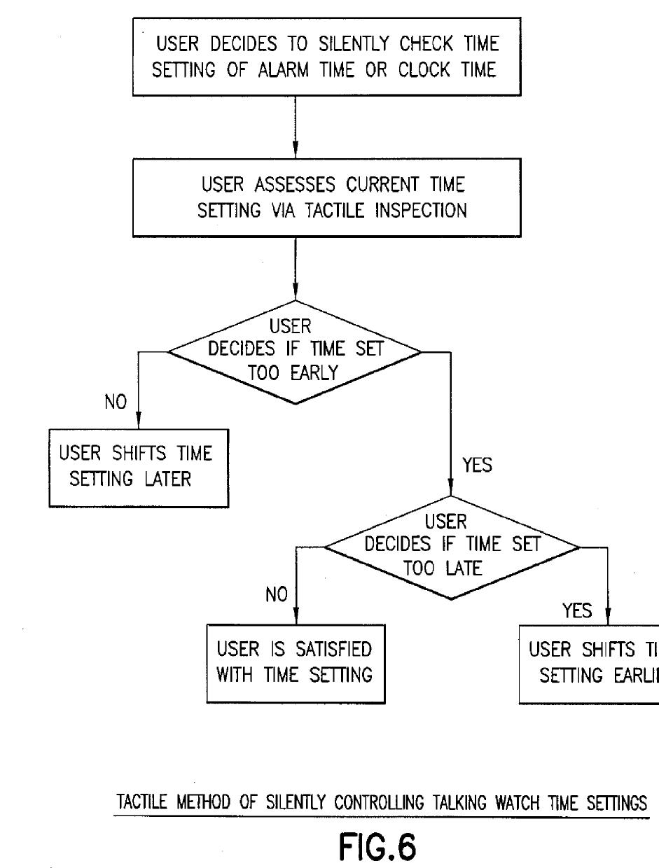

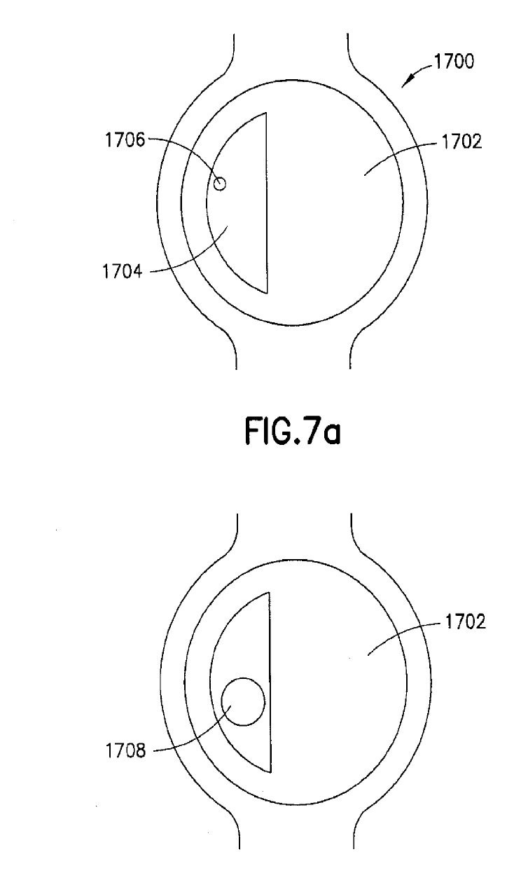

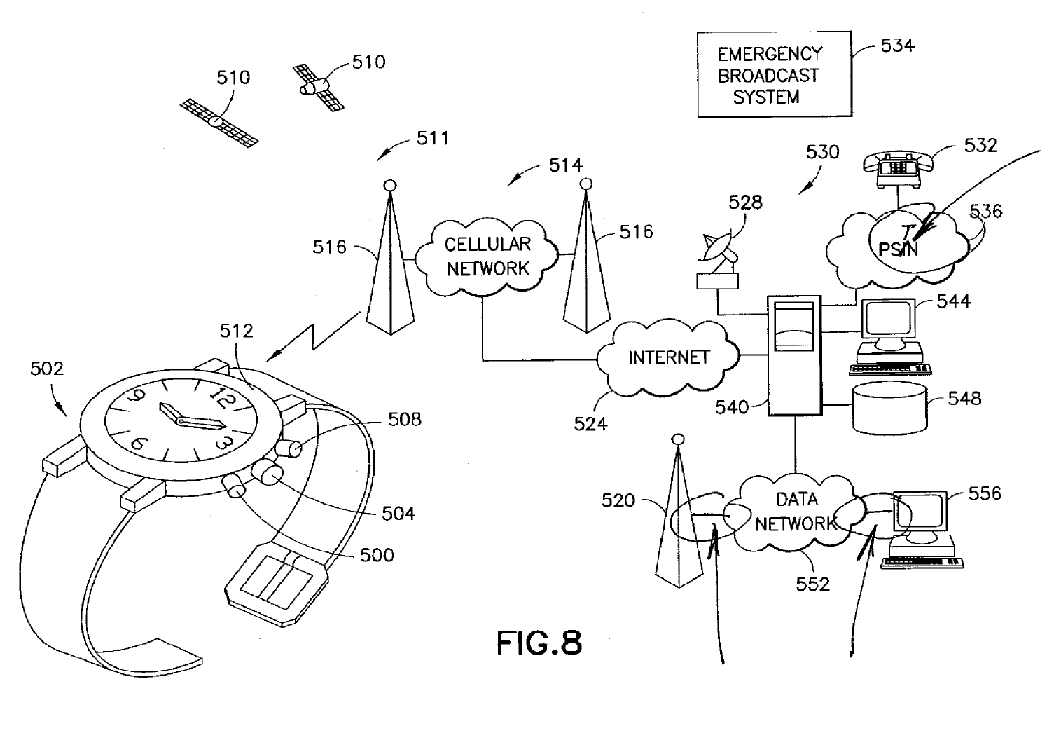

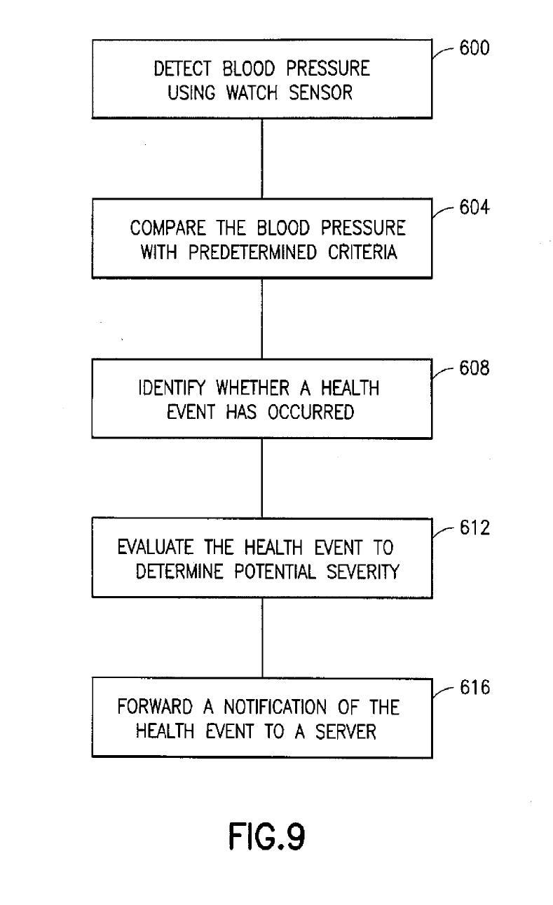

Referring again to FIG. 2, a more advanced version of the talking watch is disclosed including transceiver components 276, 272, 268, 264 and 260, antenna subsystems 280, GPS location system 256 and sensors 252. The communications components allow for the downloading of many different applications which can be incorporated into the watch including emergency broadcast applications, direction applications, health applications, amongst others. Some of these applications are disclosed below with more detail in reference to FIGS. 4 and 5.

In addition, a speech detection unit 218, 248 is disclosed in an advanced model. A small microphone 218 picks up the user's voice. This allows the user, for example, to set the time, provide alarms, or other commands. Preferably, when the user wants to set the watch, he or she will depress button 112 in FIG. 1 and clearly state the HOUR and MINUTES. The speech detection unit will detect the spoken words using conventional methods known to those skilled in the art and convert the audio statements into data commands. In a similar manner, if the user wants to set an alarm, the user could depress the button 112 twice, and then state the HOUR and MINUTES desired for the watch to provide an alarm.

The talking watch also includes geographic position locating system 256 that identifies, generates or calculates location information associated with a current location of the talking watch 100. The location information may include latitude/longitude, street address, or map coordinates, for example. Geographic position locating system 256 may be, for example, a global positioning system (GPS) that receives location data from satellites via an antenna or may use radiolocation from a cellular network to determine the current location of monitoring watch 100. Other navigation or location-determining systems may also be used, such as inertial navigation systems that update watch location as it moves from a known position, or terrestrial-based radio navigation systems, such as LORAN, TACAN or VOR. In other embodiments, geographic position locating system 256 may use transmissions or data from cellular or wireless network towers to determine a geographical location.

Referring to FIG. 3, the reliability of talking watches is substantially enhanced through a design that makes the watch water resistant or even water proof through a novel mechanical sealing mechanism. Many of the current talking watches on the market will fail within a relatively short period of time due to water damage. The components of a watch are extremely susceptible to damage from water. The novel mechanism shown in FIGS. 3A and 3B provides a water protection feature while maintaining the normal appearance of a watch. The watch surface 308 is a vertically movable surface that when depressed, exposes the speaker 312 and in another embodiment, the microphone 316 for the speech detection circuit. When exposed, the user may speak spoken commands or hear alarms, the time or other messages from the talking watch. With respect to the later, the watch may vibrate or show a light to indicate that a message is pending for the user. Alternatively, a tone can emanate from the speaker 312 that is audible even with the watch face is in the up position. Instead of the glass 322, the input device may alternatively be a button. However, the watch glass presents a simple input for visually impaired users.

Further, the water resistant mechanism 309 has the advantage of protecting the inside of the watch from water while continuing to provide the important speaker functionality necessary to provide easy to understand audio messages to the user. When the face is in the up position as shown in FIG. 3A, the watch does not allow water to enter the interior of the watch case. This is done by preferably coating the inner wall of the dial face 316 with an elastic water resistant material which expands to form a seal between the inner wall 317 and the outer wall 318 when the watch face is in the upright position shown in FIG. 3A. Any effective elastic and sealable materials known to those skilled in the art such as rubber, silicone elastomer, polyurethane, and polymers, may be used alone or in combination to make the effective water proof seal.

In another embodiment, the watch provides the ability for the user to select variable audio sound levels. The user needs to simply turn dial 108 to one of three different settings to get the desired audio level. As a further alternative shown in FIGS. 3C and 3D, the watch includes a bezel 320 that rotates to adjust a volume of the watch, as described in more detail below. Further, the watch has a glass or cover 322 that is mounted on a piezo-electric sensor 324 that actuates an audible function of the watch. In this embodiment, the glass or cover 322 is sealed with respect to a body or casing 326 of the watch. This may, for example, be implemented using the embodiment disclosed by U.S. Pat. No. 5,742,564. Furthermore, a sensor 330 (shown schematically) detects movement of the bezel using any known or hereafter developed sensor. The piezoelectric sensor 324 and sensor 330 are connected to the processor 204 to implement the functions described below.

The combination of the actuatable cover and the rotatable bezel may be used to implement multiple modes of operation. For example, during the first or normal operating mode described above, the watch keeps time and announces the current time when the cover is pressed. The bezel is rotated to adjust a volume during this first operating mode. However, if the user depresses the cover and maintains actuating pressure for more than a predetermined time period, i.e., three second, the actuator produces a second signal causing the watch to enter a second operating mode such as a time setting or alarm setting mode.

As shown in FIGS. 3E and 3F, the piezo-electric sensor 324 is monitored in the first operating mode to determine whether it has been depressed, step 350, and the bezel 320 is monitored to determine if it is rotated, step 352. If the bezel is turned, the volume is adjusted appropriately in step 353. If the piezoelectric sensor is actuated, it is determined if the actuation is a first signal, i.e., less than held for less than a predetermined time period. As an alternative, the first signal may be determined by only a single depression of the cover within a first time period. Upon determining that the first signal is actuated, the time is audibly reported at step 354. If the actuation of the cover is held greater than the predetermined time period or, alternatively, if the cover is depressed twice within a first time period similarly to double clicking a computer mouse, then the watch enters the second operating mode, step 356. The second operating mode may be a time setting mode or an alarm setting mode.

Referring to FIG. 3F, in the alarm setting mode and/or the time setting mode, the bezel is rotated to set the hours, step 360. Because the inventive wrist watch is intended to be used by a blind person, the watch may announce to the user that the bezel is to be rotated to set the hours in step 360. After the hours are set the user clicks or presses the cover to enter the minute setting portion of the alarm setting mode, step 362. Here, the minutes are set by rotating the bezel, step 364. The watch may audibly announce the hours and minutes as the bezel is rotated in steps 360 and 364. Once the minutes are set the user again presses the cover, step 366, to return to the first operating mode, step 368.

As further shown in FIG. 3E, the watch may enter a third operating mode, step 358, if the cover is depressed three times in a first time period when the watch is in the first operating mode. In each of the first, second, and third operating modes, the bezel is used to adjust or set the value of a parameter and the cover is pressed to actuate a function. Accordingly, this embodiment of the wrist watch requires only two inputs, i.e., the cover and the bezel.

As described above, the rotating bezel 320 provides a mechanism for increasing or decreasing a parameter. Instead of the rotating bezel, another device for increasing or decreasing a parameter may be used, such as for example, a bar or sliding input arranged along a side, top or bottom of the watch face. FIG. 3G shows an embodiment of a watch having a sliding input 1320 along a side of a watch face. This embodiment is particularly applicable to a square or rectangular-shaped watches. However, they can be used on watches or any shape. The sliding input 1320 is used with the cover or glass 322 as described above.

In yet a further embodiment, the input for increasing or decreasing a parameter may comprise a toggle switch 2320 arranged on the side of the watch face. The toggle switch 2320 rests in the neutral position and is actuated by pressing either the upper button 2320a to increase the parameter or the lower button 2320b to decrease the parameter. Instead of the toggle switch, buttons 2320a, 2320b may be implemented as separate buttons on the watch face. Space permitting, braille indications may be applied on the buttons 2320a, 2320b and/or the cover 322.

Furthermore, FIGS. 3A-3H depict an analog watch face with an hour hand and a minute hand. However, the watch may also be a digital watch providing a digital readout. As a further alternative, the watch may not provide a visual indication of the time.

Sight impaired users of the present invention will benefit from a watch which allows them to control basic watch functions without calling loudly attention to themselves or their disability. When changing basic settings, the use of tactile feedback instead of audio confirmation enables users to discreetly change settings without. For instance, a slider for controlling volume (1320) as shown in FIG. 3G can directly inform a user of the current volume setting via tactile touch, by sensing the relative position of the slider button within the frame of the outer watch bezel.

Similarly, a button for controlling time settings, such as, for example (2320a) in FIG. 3H, can deliver an inaudible mechanical pulse to the finger touching it, signaling the nearest number to the hour hand, and a related button, for example (2330b) in FIG. 3H, can deliver an inaudible mechanical pulse to the finger touching it, signaling the nearest number to the minute hand. For example, for the time of 10 o'clock, 2320a would deliver 10 pulses and 2320b would deliver 12 pulses.

While signals via mechanical pulses are easily and inexpensively implemented, via piezoelectric or solenoid actuators, and consume little electrical power, such a signaling process spans a time period similar to morse code signaling. Therefore, a more elegant embodiment of the present invention is shown in FIG. 4, where a solid clock face of two rotating concentric bezels 1602, 1604 are shown in a rectangular outer bezel frame, which may comprise the watch casing. Top and bottom wristband pins enable replaceable wrist straps to be easily attached to the outer bezel frame. The minute bezel 1602, with a protuberance 1606 corresponding to a traditional clock's minute hand is shown, as is an inner hour bezel 1604 with a protuberance 1608 corresponding to a traditional clock's hour hand. Although the preferred embodiment includes protuberances, cavities or other depressions in the bezels may also be used. The protuberances or cavities may be colored to provide a more readily ascertainable visual indication of the current time.

Using the talk button and rectangle frame as tactile reference points, a finger can easily discern the hour and minute hand positions, to enable users to silently mentally visualize and map the clock time. For confirmation, the talk button can pressed to hear the time announced by a prerecorded voice. For highest quality, all such recordings can be done as discrete digitally compressed recordings, one for each possible time.

To adjust the time setting, a user's finger may push on the protuberance to rotate the corresponding bezel, thus individually adjusting either the minute bezel or hour bezel to the preferred time setting, entirely silently through tactile and sensor-motor pressure.

The method for silently controlling volume to the users' satisfaction is shown in FIG. 5. It should be noted that, within the present invention, the user may make the binary decision that the volume is too low before the binary decision that the volume is too high, so that the two decision triangle steps of the method may be interchanged freely, or even both substituted with a single ternary decision triangle.

The method for silently controlling time settings to the users' satisfaction is shown in FIG. 6. It should be noted that, as with FIG. 5, within the present invention, the user may make the binary decision that the time setting is too late before the binary decision that the time setting is too early, so that the two decision triangle steps of the method may be interchanged freely, or even both substituted with a single ternary decision triangle.

A further problem with audible watches that has not been addressed is battery life. The generation of an audible signal requires more energy than the typical analog or digital time functions alone. Accordingly, wearers of audible or talking watches are required to replace the batteries more frequently. This requires taking the watch to a repair shop or sending it away for battery replacement. In both cases, this is inconvenient for the user. To minimize this inconvenience, the present invention contemplates a battery cover what is removable by a user to replace the battery. FIG. 7a shows an example of a watch with this feature. A back cover 1702 of the watch is typically removable with a special tool designed for that purpose. According to the present invention, the back cover 1702 of the watch includes a panel 1704 that is removable by actuation of a latch 1706 using a ball point pen or other similarly sharp object. FIG. 7b shows that panel removed, exposing a battery and still protecting the interior of the watch. Of course, instead of a panel, the entire back cover 1702 may also be removed using a latch.

Another historical problem with watches designed for the viewing impaired is the lack of customer support when the watch malfunctions. This problem is magnified given the inability of many vision impaired to try to reset the watch upon a malfunction. One embodiment of the invention solves this problem in a unique manner by constantly internally evaluating the operating conditions of the watch. If a problem is identified—for example, the watch stops telling time—a message is formatted and transmitted to a backend site by way of a wireless network as disclosed in reference to FIG. 8. This condition is reported to a customer agent through their PC or other device, and the customer agent will call the user to help determine the cause of the problem.

### Networked Embodiment

FIG. 8 illustrates a wrist watch 502 which can communicate with one or more backend sites 530 via one or more networks. Although illustrated as a single item, the watch may comprise a connection at the remote location to a bluetooth headset and personal computer (not shown) that can be connected to the Internet. Preferably, the watch 502 contains one or more enclosed antenna, which may be used to communicate with one or more satellite or terrestrial communications and/or navigation networks. The watch 502 may be capable of communicating with one or more networks or systems, such as cellular or mobile telephone network 514, having base stations or cell sites 516 and 520, wireless data network 552, such as a Bluetooth, WiFi, WiMAX or 802.11 network, or communications satellite 510. The watch may also be in communication with or receive signals from satellites 510, which may be part of a geographical position locating system, such as a GPS system. In one embodiment, the watch 502 receives atomic time adjustments by satellite 510.

In one embodiment, the RF receiver circuit in the watch detects radio frequency transmissions, such as transmissions in cellular frequency bands that support data communications. For example, the RF receiver circuit may be configured to detect signals at frequencies assigned to downlink or reverse-channel transmissions from cell sites 516 and 520. Any RF signals detected by the watch RF receiver circuit may be provided to the watch processor. A processor, such as processor 204 (FIG. 1), in the watch 502 may be configured to extract messages or content from the RF signals and to process the messages or content to identify specific fields, such as source and/or message type fields. The RF receiver circuit 276 may provide communications using any technology, protocol, standard or access method, such as, for example, 2G or 3G technologies known as Time Division Multiple Access (TDMA), Global System for Mobile communications (GSM), General Packet Radio Service (GPRS), Enhanced Data rates for GSM Evolution (EDGE), Enhanced GPRS (EGPRS), Code Division Multiple Access (CDMA), Wideband Code Division Multiple Access (W-CDMA), Universal Mobile Telecommunications System (UMTS), CDMA2000 1xRTT, CDMA2000 1xEV-DO, CDMA2000 1xEV-DV, or any other later developed communication technology.

The watch unit 502 may contain a satellite transmitter/receiver 272 that allows the unit 502 to receive atomic time and GPS information. Bluetooth transmitter/receiver 268 allows the watch 502 to communicate with other devices that have Bluetooth capability. For example, the watch user may wear a bluetooth headset. This allows for the audio messages to be kept private to the vision impaired user. Thus, alarms and the time are provided to the user's headset for play.

The watch 502 may also include an RFID transceiver 260 operable to detect passive or active RFID tags or transponders, for example, or within a certain distance of the watch. The detection of certain RFID tags/transmitters, or the information received from the RFID tags/transmitters, may provide location information or other nearby objects, products, or services. For example, landmarks along walking trails could have RFID tags that could ensure that the vision impaired stay along the path and do not wander into hazards. Many different types of items, however, have RFID tags that could provide multiple benefits for the vision impaired wearing the watch 502.

The watch may further include one or more antennae 280 to support communications for geographic position locating system 256, the receive/transmit transceivers 276, and RFID transceiver 260. The antennas 280 are internal to the watch 502 and may be formed as an integral part of a housing for watch 502.

Server 540 at the backend site may be any processor-based system that is capable of communicating with external networks and processing data associated with watches 502. Server 540 may be coupled to multiple networks, such as cellular network 514 or wireless data network 552 which couple server 540 to other communication networks, and may be any public or private data network, such as an Internet, intranet, extranet, or wide or local area network (WAN/LAN). Server 540 may be coupled to satellite 510 via antenna 528. In one embodiment, users may communicate with server 540 via a local or remote personal computer (PC), laptop computer, or terminal, such as devices 544 or 556. Alternatively, server 540 may communicate with watch users via a wireless device (not shown) or a wireline connection, such as telephone 532, using, for example, voice signals, an interactive voice response (IVR), a voice response unit (VRU), or dual tone multi-frequency (DTMF) tones. Telephone 532 may be coupled to public switched telephone network (PSTN) 536.

Memory 548 may be used to store information, such as user account data and user profile data, such as that described below relating to alarms and other messages. Server 540 may access data stored on memory 548 and may store data to memory 548. Users may access memory 548, for example, to enter, update, or edit account data, via terminals or computers 544. Memory 548 may be internal or external to server 540 and may be located near to or remote from server 540. Communications between the watch unit 502 and server 540 may be via cellular network 514, data network 552 and/or communication satellite network 511 depending upon availability of each network, the urgency of the message, and/or user configuration.

The watch 502 may transmit messages to server 540, such as health parameters for health applications, requests for emergency services, or requests for watch customer service support. Server 540 may then take action to record and report. For example, server 540 may report an emergency message from the watch user to his or her caregiver or hospital emergency services, for example.

In most instances, for example, the server 540 can be configured to take certain action upon receiving notices of certain events. Server 540 is tied to the Emergency Broadcast System, Weather Services, or other health services. If an emergency or weather event occurs in the location of the watch user (which is known from GPS), server 540 may send and command the watch 502 to broadcast warnings, such as short audible messages or tones to the wearer of the watch. Additionally, server 214 may report the wireless device use to the driver's parent, supervisor, fleet manager or other authority. Such vehicle operation violations may trigger any number of actions preselected by the user and/or default actions in server 214.

The watch 502 may also include a health application. For example, a sensor 122 such as that known to one skilled in the art could be placed on the back side of the watch or could be internal to the watch but have a sensor on the surface of the watch. The sensor can provide information to the watch processor such as blood pressure. If blood pressure is sensed over certain thresholds for a certain user, the blood pressure and time of day are formatted into packets and forwarded over a network to the server. In this case, the watch unit can also issue an audio or tone alarm to the user. In addition, the user can enter other certain limited health information by issuing short commands by voice which are routed to the audio recognition system in the watch. Such information can be formatted into messages and sent to the server 540 for further processing and action as will be understood by those skilled in the art.

The watch unit 502 can also communicate via RF, infrared, or other communications means well known in the art with traffic networks. For example, the watch unit can receive signals from stop lights that indicate whether it is safe to walk of not. Such messages may warn the watch user of violations and/or direct the user to discontinue the action or violation.

The server 540 may further include a street mapping database for use with geographic position locating system 115 and/or processor 103. For example, street mapping database may include street maps for multiple locations and street data for specific streets. The data in street mapping database may be stored in a compact disc (CD), digital video disc (DVD), random access memory, read only memory, electrically erasable programmable memory, or other magnetic media or electronic storage. In one embodiment, the server 540 can use the geographic position locating system to determine a current location of the watch and use the data from a street mapping database to locate and provide information relating to close landmarks or restaurants, such as on the current street on which the user may be walking. Additional information may be presented to the user, such as locations, weather conditions, or the like. A geographic position locating system may also be used to calculate, determine and/or display routing information to a selected destination.

Watch processor may be configured to identify alarm conditions, such as messages from the emergency broadcast system which are received by the receive/transmit unit. The speaker is coupled to a processor and may provide audio warnings and alerts to the user. Upon detection of an alarm condition, the processor may command speaker to present a warning to the user, such as an audible tone or message via a speaker (not shown) or a visual warning via a warning light on the watch (not shown).

In another embodiment, the watch contains a diagnostic system. The watch diagnostic system may be software that operates with the watch processor and is preferably stored in ROM. The watch diagnostic system provides access to time and date data, preset alarm messages or other data. If the watch stops, for example, the diagnostic system sends out a message indicating failure. This message is preferably sent by the watch to a wireless communications network 514 to the backend customer support center 520. Upon receipt of the message on his or her terminal or other device, the customer support agent can call the watch user and assist in fixing the watch or indicating where to send the watch for repair or replacement.

FIG. 9 illustrates a flowchart for an exemplary embodiment of a method for processing a health event of a patient wearing the wrist watch. The method illustrated in FIG. 9 may be implemented, for example, using watch 502. Moreover, it will be understood that the steps of the methods illustrated in FIG. 9 may be performed in the order indicated, or in any other order, or simultaneously, or in conjunction with other steps or methods. In step 600, a sensor on the back of the watch detects a heart rate. The processor in the watch then determines the user's blood pressure by using an algorithm. The blood pressure is then compared to predetermined criteria in step 604. If this comparison indicates that a ‘health event” (for example, abnormally high blood pressure) has occurred in step 608, the health event will be given a tag indicating the level of severity in step 612. At that point, an audio or tone alarm is sounded by the watch and a notification of the health event is sent to a server in step 616. Of course, this is but one of many examples of health applications that could be incorporated into the watch.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A timepiece, comprising:
a casing;
a time-keeping portion arranged in said casing;
an actuator;
an announcing portion producing an audible announcement indicating a current time in response to a first signal produced by said actuator in a first operating mode;
an input device, wherein said actuator produces the first signal when said input device is pressed by a user; and
a volume adjustment adjustable to increase and decrease a volume of said announcement.

2. The timepiece of claim 1, wherein said input device is one of a cover, a bezel, or a timepiece glass.

3. The timepiece of claim 1, wherein said actuator is a piezoelectric sensor.

4. The timepiece of claim 1, further comprising a controller monitoring said actuator and said volume adjustment, said controller changing operation of the timepiece to a second operating mode if the input device is depressed so as to produce a second signal.

5. The timepiece of claim 4, wherein said second signal is produced by one of:
depressing the input device two times within a first time period; and
depressing the input device for a duration greater than a predetermined time period.

6. The timepiece of claim 4, wherein said controller switched operation of the timepiece to a third operating mode when the actuator produces a third signal.

7. The timepiece of claim 6, wherein the second signal is produced by depressing the input device two times within a first time period, and the third signal is produced by depressing the input device three times within the first time period.

8. The timepiece of claim 6, wherein the second operating mode is a time setting mode and the third operating mode is an alarm setting mode.

9. The timepiece of claim 4, wherein the second operating mode is a time setting mode.

10. The timepiece of claim 4, wherein the second operating mode is an alarm setting mode.

11. The timepiece of claim 4, wherein said volume adjustment is used to adjust a volume parameter in said first operating mode and to adjust a second parameter in said second operating mode.

12. The timepiece of claim 6, wherein said volume adjustment is used to adjust a volume parameter in said first operating mode, and to adjust different parameters in said second and third operating modes.

13. The timepiece of claim 1, wherein said volume adjustment is a rotatable bezel.

14. The timepiece of claim 1, wherein said volume adjustment is a toggle having an increase and a decrease buttons.

15. The timepiece of claim 1, wherein said volume adjustment includes two separate buttons.

16. The timepiece of claim 1, wherein the volume adjustment and the cover are the only inputs of the timepiece.

17. The timepiece of claim 1, further comprising a battery cover having a latch that is actuatable by a user to access a battery in the watch for replacement.

18. The timepiece of claim 1, wherein the latch is actuatable using a ballpoint pen tip.

19. A method for adjusting the volume setting of a timepiece, comprising:
a) deciding to check volume setting;
b) using tactile sense to estimate current volume setting;
c) deciding whether current volume setting is too high or too low or satisfactory,
d) using tactile sense and sensor-motor pressure to adjust volume setting lower if too high or adjusting volume setting higher if too low.

20. A method for adjusting the time of alarm or display time setting of a timepiece, comprising:
a) deciding to check time setting;
b) using tactile sense to estimate current time setting;
c) deciding whether current time setting is too early or too late or satisfactory,
d) using tactile sense and sensor-motor pressure to adjust time setting later if too early or adjusting time setting earlier if too late.
